(19) United States
(12) Patent Application Publication
(10) Pub. No.: US 2011/0191856 A1
(43) Pub. Date: Aug. 4, 2011

(54) RECEIVING INPUT DATA

(76) Inventor: Dominic John Keen, London (GB)

(21) Appl. No.: 12/919,179

(22) PCT Filed: Feb. 24, 2009
(86) PCT No.: PCT/GB2009/000492

§ 371 Date: Apr. 21, 2011

(30) Foreign Application Priority Data
Feb. 25, 2008 (GB) 0803375.5

(51) Int. Cl. G06F 21/00

(52) U.S. Cl. 726/26

(57) ABSTRACT

A method of securing the inputting of sensitive information by a user, the method comprising: generating a mapping that associates each symbol of a plurality of symbols with a respective location at which to display that symbol on a display; displaying the plurality of symbols to the user, each symbol being displayed at the associated location on the display according to the generated mapping; the user providing a sequence of selections, each selection being a selection of a respective one of the locations; and converting the sequence of selections into a corresponding sequence of input symbols representing the input from user, each input symbol being the symbol associated with the respective selected location in the sequence of selections according to the generated mapping.

### FIELD OF THE INVENTION

The present invention relates to a method of receiving an input from a user and an apparatus and a computer program arranged to carry out such a method.

### BACKGROUND OF THE INVENTION

It is known that certain information and data usually needs to be kept secret, such as bank account numbers, passwords (such as a personal identification number (PIN)), private telephone numbers, credit and debit card numbers, etc. It will be appreciated that many other types (or classes) of information also generally need to be kept secret. In this specification, such information shall be referred to as sensitive information (although terms such as restricted information, secret information and secure information may also be used).

To actually use the sensitive information, the information often has to be input (or entered or provided) by a user. For example, for a user to be able to, access certain data records stored on a computer, the user may have to input a password or a PIN (i.e. sensitive information). If the user correctly enters a valid password or PIN, then that user will be provided access to those data records. Conversely, if the user does not correctly enter a valid password or PIN, then that user will not be provided access to those data records. As another example, for a user to access details about his bank account, he must correctly enter his bank account number (i.e. sensitive information). Furthermore, for a user to perform a credit card purchase over the Internet, the user will have to enter his credit card number (i.e. sensitive information).

Once the sensitive information has been provided by the user, then the storage, transmission and processing of that sensitive information should be performed in a secure manner. There are various known mechanisms, often based on encryption, decryption and cryptographic authentication mechanisms, for performing such operations in a secure manner.

FIG. 1 of the accompanying drawings schematically illustrates an exemplary networked system 100. A first computing apparatus, in the form of a conventional computer 102 (such as a desktop computer, a personal computer, a laptop, a mainframe computer, etc.) is provided. This computer 102 comprises a processor 104a, a keyboard 106a and a screen (or monitor or display) 108a. As is known in this field of technology, the processor 104a performs various processing operations, and may process data received as an input from the user via the keyboard 106a. The results of the processing performed by the processor 104a may be displayed to the user on the screen 108a.

Other known means of providing input from the user to the processor 104a, such as a mouse and a track-ball, may be used. The screen 108a may be touch-sensitive, so that the user may provide an input to the processor 104a by touching or pressing the screen 108a (e.g. with a finger or a pointer), with the input by the user being dependent on the position at which the user touches or presses the screen 108a. Additionally, a microphone 110a may be provided for the user to provide an audio input to the processor 104a.

The computer 102 is connected, via a network 112, to a computer system 114. The network 112 may comprise one or more of: the Internet, a local area network, a wide area network, a metropolitan area network, etc. The computer system 114 and the computer 102 communicate with each other, and exchange data with each other, over the network 112. The computer system 114 may comprise one or more computers, servers, etc. for providing various functionality to the computer 102, as discussed in more detail later.

In addition to, or as an alternative to, the computer 102, the networked system 100 comprises a mobile device 116 (such as a mobile telephone, a personal digital assistant, a pager, a laptop, etc.), i.e. a portable device that a user may carry around with him. Similar to the computer 102, the mobile device 116 comprises a processor 104b, a keyboard 106b and a screen (or monitor or display) 108b. As is known in this field of technology, the processor 104b performs various processing operations, and may process data received as an input from the user via the keyboard 106b. The results of the processing performed by the processor 104b may be displayed to the user on the screen 108b. Again, the screen 108b may be touch-sensitive, so that the user may provide an input to the processor 104b by touching or pressing the screen 108b. Many such mobile devices 116 comprise a microphone 110b which enables the user to provide an audio input to the processor 104b.

The mobile device 116 is connected, via the network 112, to the computer system 114. The mobile device 116 may be arranged to communicate wirelessly with the network 112 via voice channels and data channels, as is well known in this field of technology. As such, the network 112 may comprise well known telecommunications apparatus for performing telephonic communications and for converting between telephonic/wireless communications and IP-based or network-based communications.

As mentioned, the system 100 is merely exemplary, and other apparatus forming part of the system 100 may be used by a user. These other devices may have a keyboard 106 (with one or more keys or buttons) with which the user can provide his input, and a display 108 capable of displaying data and information to the user. Alternatively, these other devices may simply have a touch-sensitive display 108 for both receiving the user input and displaying information to the user. Such a device could be, for example, an ATM machine (also known as a cash-machine or a cash dispenser), which usually uses a keyboard 106 to allow a user to enter a PIN associated with a debit card or a credit card in order to perform transactions with that debit card or credit card. Additionally, payment by a credit card or a debit card is increasingly requiring a user to enter a PIN associated with that credit card or debit card at a device that is provided by a retailer, restaurant, etc. All of these additional types of devices and machines may form part of the system 100 in a similar manner to the computer 102 and the mobile device 116, and may communicate over the network 112 with a computer system 114. The system 100 may thus comprise zero or more such additional types of devices, zero or more computers 102 and zero or more mobile devices 116, with these numbers potentially varying over time.

The remainder of this description will therefore be described with reference to just the mobile device 116. However, it will be appreciated that the following description applies equally to the computer 102 and to any of the above-mentioned additional devices. It will be appreciated that some devices only make use of a touch-sensitive display 108 and are not provided with a keyboard 106, whilst the display 108 of other devices may not be touch-sensitive.

A user may need to enter sensitive information at the mobile device 116. This sensitive information may be data that is used solely at the mobile device 116. For example, it may be a password or PIN that the user uses to log-in to the mobile device 116. In this case, the mobile device 116 may not currently form part of the system 100 and may be added to the system 100 once the user has logged-in to the mobile device 116. After the user has logged-in to the mobile device 116, the sensitive information that the user input is no longer stored by the mobile device 116.

The sensitive information may, instead, be data that the user enters at the mobile device 116 for storage at the mobile device 116 so that the user can access and use it later.

Alternatively, the sensitive information may be data that is to be transmitted to the computer system 114. For example, the computer system 114 may be operated by a bank to allow a bank account holder to access his bank account via the network 112. In this case, the user may have to enter the bank account number, and possibly a password, at the mobile device 116, with the mobile device 116 subsequently transmitting this data to the computer system 114 so that the bank account information can be accessed by the mobile device 116. As another example, the computer system 114 may be operated by a sales outlet (such as a florist selling flowers or a retailer of train tickets) and the user may wish to buy something from the sales outlet. In this case, the user may have to enter a credit card number at the mobile device 116, with the mobile device 116 subsequently transmitting this data to the computer system 114 so that the credit card information can be used to complete the user's desired purchase.

Although the storage and transmission of sensitive information can often be performed, in a secure manner (using encryption, cryptographic authentication, etc. as is known in this field of technology), the actual input and entry of the sensitive information by the user is often not performed in as secure a manner. For example, it is known for so-called key-logger applications to be surreptitiously installed on the mobile device 116 and which, unbeknownst to the user, are executed by the processor 104b to create a record, or log, of the various keystrokes entered by the user at the keyboard 106b. In this way, an attacker may use the key-logger application to determine the sensitive information entered by the user by inspecting the log of keystrokes generated by the key-logger application. For example, when a user types in a password using the keyboard 106b, the sequence of keystrokes corresponding to that password will be recorded by the key-logger application, thereby revealing the password to the attacker. This breach of security would occur regardless of any subsequent cryptographic techniques that are used to secure the storage and transmission of the password.

Additionally, an application that logs which parts of a touch-sensitive display 108b have been pressed may be surreptitiously installed on the mobile device 116 and may, unbeknownst to the user, be executed by the processor 104b to create a record, or log, of the various display-touches entered by the user. Thus, in a similar manner to the above-described key-logger application, such an application may be used to determine what information a user has input via the touch-sensitive display 108b, and, when this information is sensitive information, a security breach will then have occurred.

Furthermore, when a user needs to enter data (such as a PIN at an ATM), it is sometimes possible for somebody to visually observe the keystrokes used by that user. That observer may then be able to make use of the observed keystrokes. This is known as “shoulder-surfing”. For example, that observer may have observed the keystrokes used by a user for entering a PIN for a credit card. If that observer then steals that credit card, he can make use of the credit card as he knows how to enter the PIN.

Further security concerns involve so-called “phishing”, in which an attacker pretends to be a different entity to fool a user into interacting with the attacker in the mistaken belief that he is interacting with that different entity. In this way, the user may be fooled into divulging sensitive information to the attacker that they would not normally have revealed to the attacker.

Additionally, it may be possible for an attacker to intercept a transmission between a transmitter and a receiver and interpret the intercepted data, which may include sensitive information. This might require the attacker knowing how to decrypt the intercepted data.

It would therefore be desirable to improve the methods of receiving input data from the user to overcome these security problems.

Furthermore, some operators of the computer system 114 may require a user to authenticate himself with that computer system 114 using so-called “voice biometrics”. In such a system, the user registers an amount of voice data with the computer system 114. For example, the user, when registering with the computer system 114, may have been instructed to speak a set of tokens, words, phrases, etc. (such as the numbers “0”, “1”, “2”, . . . , “9”) into the microphone 110b at the mobile device 116. Audio data representing these spoken tokens are then transmitted to the computer system 114 which stores this data as reference audio data. This may be stored, for example, as part of a profile that is maintained for that user. Then, when the computer system 114 requires the user to authenticate himself, the computer system 114 requests the user, via the mobile device 116, to speak a series of the tokens, words, phrases, etc. (usually a randomised series) into the microphone 110b. The computer system 114 can then compare the audio data representing the tokens currently spoken by the user in response to this request with the reference audio data being stored as part of that user's profile. If the comparison is successful, then the identity of the user has been authenticated.

Such voice biometrics authentication may be used on its own or it may be used in addition to other authentication mechanisms, such as the above-described entry of sensitive information (such as a PIN) to authenticate the identity of a user.

With current mobile devices 116, the use of voice biometrics is achieved by establishing a voice channel with which to communicate the spoken tokens from the user to the computer system 114 for authentication. However, if the processor 104b of the mobile device 116 is executing an application that is communicating over the network 112 by a data channel, then the establishment of a voice channel by the mobile device 116 for the voice biometrics authentication invariably causes that application to be terminated. For example, the mobile device 116 may be executing an application (such as a web browser) that allows the user to communicate via a data channel with a website run by a florist (and being provided by the computer system 114) so that the user can purchase flowers. Then, when the user has to pay for the flowers, the user may be required by the computer system 114 to provide voice biometrics authentication. A voice channel is therefore established to communicate the users spoken tokens and, in doing so, the application may be terminated or, at the very least, some of the data being stored in relation to the application may be lost. Once the voice channel has been used to successful authenticate the user, then the application will need to be restarted and any data that has been lost will have to be re-entered.

Naturally, this is very inconvenient for the user, as it slows down the transactions with the computer system 114. It may require the user to re-enter data that had been previously entered, which takes time and may be a source of errors.

It would therefore be desirable to improve the methods of receiving input data from the user to overcome these problem.

### SUMMARY OF THE INVENTION

According to an aspect of the invention, there is provided a method of securing the inputting of sensitive information by a user, the method comprising: generating a mapping that associates each symbol of a plurality of symbols with a respective location at which to display that symbol on a display; displaying the plurality of symbols to the user, each symbol being displayed at the associated location on the display according to the generated mapping; the user providing a sequence of selections, each selection being a selection of a respective one of the locations; and converting the sequence of selections into a corresponding sequence of input symbols representing the input from the user, each input symbol being the symbol associated with the respective selected location in the sequence of selections according to the generated mapping.

In this way, the meanings of the symbols (i.e. the information represented by the symbols) are separated from (i.e. divorced from) the display locations. Thus, the link between the locations and the meanings is removed so that key-logger applications and the like will no longer pose a security threat when inputting sensitive information. Embodiments of the invention therefore transform the plurality of symbols into an arrangement of locations at which the symbols are displayed, where the locations do not necessarily correspond to what the symbols represent.

According to another aspect of the invention, there is provided a method of receiving a plurality of inputs from a user, the method comprising: for each input from the user: generating a mapping that associates each symbol of a plurality of symbols with a respective location at which to display that symbol on a display; displaying the plurality of symbols to the user, each symbol being displayed at the associated location on the display according to the generated mapping; the user providing a sequence of selections, each selection being a selection of a respective one of the locations; and converting the sequence of selections into a corresponding sequence of input symbols representing the input, each input symbol being the symbol associated with the respective selected location in the sequence of selections according to the generated mapping; wherein the mapping generated for a first input from the user is different from the mapping generated for a second input from the user.

In this way, the key-strokes used for entering the same data (e.g. a PIN) changes from one input to the next. Thus, the meanings of the symbols (i.e. the information represented by the symbols) are separated from (i.e. divorced from) the display locations, as a symbol may displayed at one location for a first user input but may then be displayed at a second location for a subsequent user input. Thus, the link between the locations and the meanings is removed so that key-logger applications and the like will no longer pose a security threat when inputting sensitive information. Embodiments of the invention therefore transform the plurality of symbols into an arrangement of locations at which the symbols are displayed, where the locations do not necessarily correspond to what the symbols represent, with this transformation being updated on an input-by-input basis, e.g. for each key-stroke or symbol selected, or for each string of symbols entered (e.g. for each password entered).

The plurality of symbols may have a natural ordering, in which case the mapping may be generated independently of that natural ordering. The mapping may be a substantially random mapping to help improve security.

The step of generating may be performed at least in part at a first system, with the steps of displaying and providing then being performed at a second system distinct from the first system. This helps improve the security of the system. In some such embodiments, the step of generating may comprise: the first system generating a seed value and communicating the seed value to the second system; and the second system using the seed value to generate the mapping. In other embodiments, the step of generating may comprise the first system: generating a seed value; using the seed value to generate the mapping; and communicating the mapping to the second system. Further embodiments comprise: the first system generating the mapping; the first system communicating image data to the second system, the image data defining an image which, when displayed at the second system, depicts the plurality of symbols at the associated locations in accordance with the generated mapping; and the second system displaying the plurality of symbols by displaying the image defined by the image data.

In some embodiments, the step of converting is performed at the first system, the method comprising communicating the sequence of selections from the second system to the first system. This helps improve the security by reducing the amount of information and processing at the second system.

The first system could be a system that is kept secure (e.g. access to it is restricted and closely monitored, such as a server for a bank) whilst the second system could be an apparatus used by the public (such as a mobile telephone or a personal computer). As such, the second system may be more vulnerable to attacks, for example via the above-mentioned methods using key-logging applications etc. Hence, security can be increased if the second system performs less processing and is exposed to a reduced amount of information, with more processing and information handling being performed by the first system instead.

Additionally, the first system may be arranged to work with multiple different types of second system. These different types of second system may be, for example, personal computers, personal digital assistants, mobile telephones, laptops, etc. Furthermore, second systems of the same type may be configured differently from each other. Hence, it is advantageous if the majority of the processing for embodiments of the invention is performed at the first system, as doing so makes it easier to support a wider range of types of second systems in various configurations.

In some embodiments, the method comprises a step of checking the input from the user by comparing the sequence of input symbols with a reference sequence of symbols from the plurality of symbols. This is performed, for example, for PIN and password entry. This step of checking may be performed at the first system.

In some embodiments, the method comprises detecting that the user is about to provide an input, wherein the step of generating is performed in response to a detection that the user is about to provide an input.

Additionally, the step of generating may comprise selecting the locations to use for the mapping from a set of available locations.

In accordance with another aspect of the invention, there is provided a system adapted to secure the inputting of sensitive information by a user, the system comprising: a display; a mapping generator for generating a mapping that associates each symbol of a plurality of symbols with a respective location at which to display that symbol on the display; a display controller for displaying the plurality of symbols to the user, each symbol being displayed at the associated location on the display according to the generated mapping; means for receiving a sequence of selections from the user, each selection being a selection of a respective one of the locations; and a converter for converting the sequence of selections into a corresponding sequence of input symbols representing the input from the user, each input symbol being the symbol associated with the respective selected location in the sequence of selections according to the generated mapping.

In accordance with another aspect of the invention, there is provided a system adapted to receive a plurality of inputs from a user, the system comprising: a display; a mapping generator for generating a mapping that associates each symbol of a plurality of symbols with a respective location at which to display that symbol on the display, wherein the mapping generated for a first input from the user is different from the mapping generated for a second input from the user; a display controller for displaying the plurality of symbols to the user, each symbol being displayed at the associated location on the display according to the generated mapping; means for receiving a sequence of selections from the user, each selection being a selection of a respective one of the locations; and a converter for converting the sequence of selections into a corresponding sequence of input symbols representing the input from the user, each input symbol being the symbol associated with the respective selected location in the sequence of selections according to the generated mapping.

In embodiments of the invention, these systems may be arranged to carry out any of the above-mentioned methods.

According to another aspect of the invention, there is provided a method of receiving audio input from a user at a mobile device, in which the device is operable to communicate via a voice channel and a data channel and in which the device is executing an application that communicates with a computer system via a data channel, the method comprising: determining that audio input is required from the user; the application recording data representing audio input received from the user via a microphone of the mobile device; and the application transmitting the recorded data to the computer system via the data channel.

In this way, a voice channel does not need to be established to communicate the audio data input by the user from the mobile device to the computer system. This results in not having to terminate the application being executed by the mobile device and not losing data that has been entered into the application.

The step of recording may comprise the application activating the microphone and subsequently deactivating the microphone.

Additionally, some embodiments of the invention comprise the step of checking the audio input received from the user by comparing the transmitted recorded data with reference audio data.

According to another aspect of the invention, there is provided a mobile device capable of communicating via a voice channel and a data channel, the device comprising: a microphone; a memory storing an application arranged to communicate with a computer system via a data channel; and a processor for executing the application; wherein the application is arranged to record data representing audio input received from the user via the microphone and communicate the recorded data to the computer system via a data channel.

The device may comprise means, under the control of the application, for activating the microphone and subsequently deactivating the microphone.

According to another aspect of the invention, there is provided a system comprising: one of the above-mentioned mobile devices; and a computer system arranged to communicate with the device via a data channel, the computer system comprising means for checking the recorded audio input received from the user by comparing the recorded data with reference audio data.

According to another aspect of the invention, there is provided a computer program which, when executed by a computer, carries out any one of the above-described methods. The computer program may be carried on a data carrying medium, which may be a storage medium or a transmission medium.

### BRIEF DESCRIPTION OF THE DRAWINGS

Embodiments of the invention will now be described, by way of example only, with reference to the accompanying drawings, in which:

FIG. 1 schematically illustrates an exemplary networked system;

FIGS. 2, 3a, 3b, 3c, 3d, 3e, 3f and 3g schematically illustrate symbols displayed on a display according to embodiments of the invention;

FIG. 4 schematically illustrates a flow-diagram for receiving an input from a user according to an embodiment of the invention;

FIG. 5 schematically illustrates an alternative flow-diagram for receiving an input from a user according to an embodiment of the invention;

FIG. 6a schematically illustrates a mobile device arranged to carry out the embodiments of the invention;

FIGS. 6b and 6c schematically illustrate systems arranged to carry out the embodiments of the invention;

FIG. 7 schematically illustrates a flow-diagram for receiving audio input from a user at a mobile device; and

FIG. 8 schematically illustrates an apparatus for carrying out the processing shown in FIG. 7.

### DETAILED DESCRIPTION OF EMBODIMENTS OF THE INVENTION

In the description that follows and in the figures, certain embodiments of the invention are described. However, it will be appreciated that the invention is not limited to the embodiments that are described and that some embodiments may not include all of the features that are described below. It will be evident, however, that various modifications and changes may be made herein without departing from the broader scope of the invention as set forth in the appended claims.

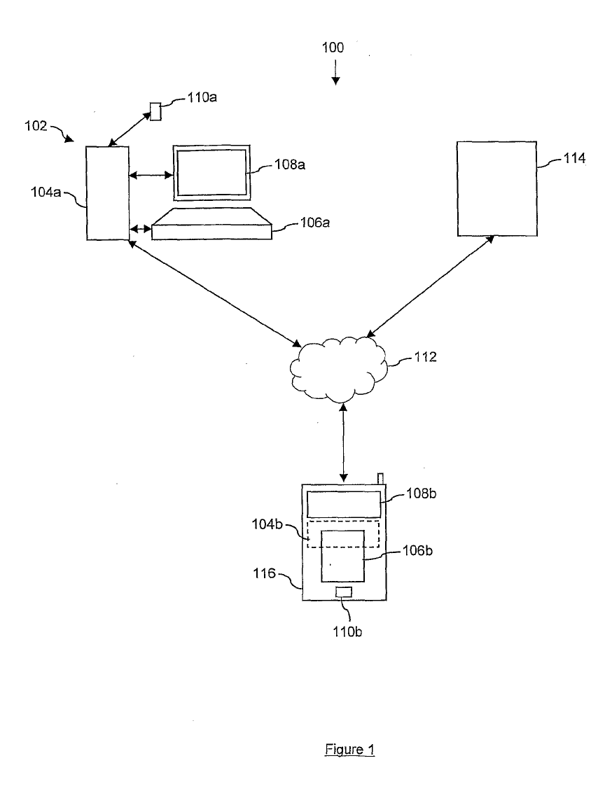

Embodiments of the invention will be described with reference to the system 100 described above with reference to FIG. 1. In particular, embodiments of the invention will be described using the mobile device 116 as an example of a device at which a user provides an input and which receives the input from the user. However, it will be appreciated that the embodiments described below apply equally to the computer 102 and to any of the other above-mentioned additional devices (such as ATM machines, and credit card and debit card payment devices). It will also be appreciated that, unless stated otherwise, embodiments of the invention do not need to make use of the networked system 100, and may be used by the above-mentioned devices in isolation from the networked system 100 (for example when data is to be entered at a device and used solely by that device).

The mobile device 116 executes a computer program for carrying out a method for receiving input from a user, as described in more detail below. This may also involve the computer system 114 executing a computer program for use in coordination with the mobile device 116. These computer programs may be stored on a storage medium (such as a ROM, a RAM, a CD-ROM, a DVD-ROM, a BluRay disk, a memory card/device, etc.). These computer programs may be stored on a transmission medium (such as the data communication channels established in the networked system 100).

In embodiments of the invention, information is to be input by a user at a device (such as the mobile device 116) and received from the user at that device. The information may relate to and comprise sensitive information. However, embodiments of the invention apply equally to information that does not comprise sensitive information.

The information to be input by the user may be considered to comprise one or more symbols. Each of the symbols of this input data may be selected by the user from a plurality, or a set, of available symbols. For example, if the symbols are to be numbers and the input data is to be numerical, then the set of symbols may be {0,1,2, . . . , 9}, whereas if the symbols are to be letters and the input data is to be purely textual, then the set of symbols may be {a,b, . . . , z}.

A symbol may be a number, a letter, a punctuation mark, or, indeed, any character or token, so that the information entered by the user is then a sequence of one or more symbols, such as a numerical string, a series of letters, an alphanumeric sequence, etc.

The set of symbols may have a natural, or customary or standard, ordering (or arrangement). For example, when the symbols are numbers, the orderings 0,1,2, . . . , 9 and 1,2, . . . , 9,0 are normal, and when the symbols are letters, the usual alphabetic ordering is normal. The ordering (or arrangement) may be a 1-dimensional ordering, as in the examples given above. However, the ordering (or arrangement) may be multi-dimensional. For example, the natural ordering may be 2-dimensions, such as (a) the standard QWERTY layout for letters on a keyboard or (b) the standard arrangement of number buttons on a telephone or credit card payment device.

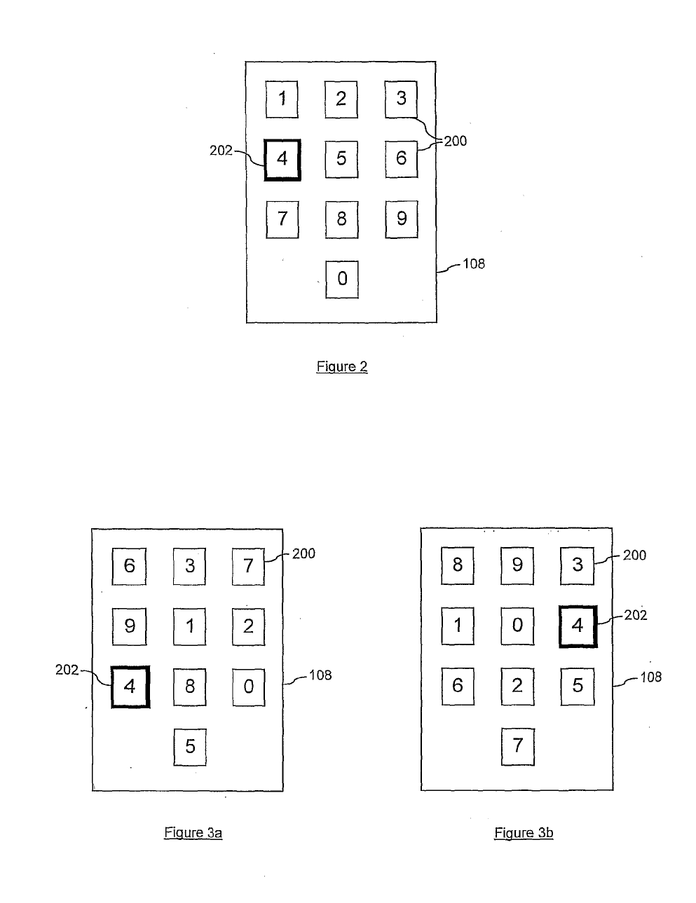

In an embodiment of the invention, the set of symbols to be used for the information to be entered by the user is displayed on the display 108b. These symbols are displayed in a particular order (as will be described below in more detail). The ordering may be a 1-dimensional ordering (in which the symbols are displayed in a row or a line) or may be 2-dimensional ordering (in which the symbols may be ordered by a first coordinate and then a second coordinate of the 2-dimensional display). FIG. 2 schematically illustrates the symbols displayed on the display 108b when the set of symbols to be used comprises numbers. In FIG. 2, the set of symbols is displayed in a customary 2-dimensional order (or arrangement)

Displaying the set of symbols involves displaying, for each of the symbols in the set of symbols, a respective image depicting that symbol, with this image being displayed at a location (or position) 200 on the display 108b based on the order in which the symbols are to be displayed. Thus, the order that is used is a mapping that associates a symbol from the set of symbols with a location 200 on the display 108b. A location 200 may be considered to be a point, or a coordinate, on the display 108b, or it may be a region or an area of the display 108b. In FIG. 2, ten locations 200 are used for displaying the symbols, each one corresponding to a respective one of the ten available symbols 0, 1, 2, . . . , 9. This can be achieved (i) by using a plurality of images, each of the images depicting one or more of the symbols in the set of symbols, and then displaying each of these plurality of images so that the symbols are displayed at their associated locations 200 from the mapping or (ii) by using a single image that depicts all of the available symbols in the set of symbols at their associated locations from the mapping, and then displaying that single image. Using FIG. 2 as a reference, method (i) may be achieved by (a) using a separate image for each of the symbols, so that 10 separate images are used; (b) using a separate image for each row of symbols, so that 4 separate images are used; (c) using a separate image for each column of symbols, so that 3 separate images are used; or (d) using other groupings of symbols to form images for display.

It will be appreciated that method (ii) is essentially the same as method (i) and has the same result, it only differing in how the image files are stored and then called upon by the processor 104b to be displayed. Thus, method (ii) in effect displays a plurality of images (as per method (i)), with these images actually being sub-images of the single overall image displayed in method (ii).

If there are not enough locations 200 on the display 108b to display all of the symbols in the set of symbols (i.e. there are more symbols in the set of symbols than there are locations 200), then a sub-set of the set of symbols is displayed on the display 108b, and a mechanism for changing the particular sub-set displayed is provided, such as displaying arrows (not shown) for the user to select to allow him to move forwards and backwards through various sub-sets of the set of symbols.

The locations 200 are selectable by the user to allow the user to select and input the symbol displayed at a location 200. A user may select a particular symbol in a variety of ways. For example, the display 108b may be touch sensitive, in which case the user may simply touch the display 108b at the location 200 at which the desired symbol is displayed, thereby selecting and inputting that symbol. Consequently, the locations 200 may be implemented as areas of the display 108b, as opposed to distinct points on the display 108b. Alternatively, when the user uses the keyboard 106b, the user may use certain keys (such as cursor-keys or a scroll key or forwards and backwards keys) as is well-known) to move a displayed cursor 202 to highlight one of the locations 200. The cursor 202 may be, for example, an enhanced border or edge displayed around a currently highlighted or chosen location 200 or symbol. Alternatively, the cursor 202 may be achieved by inverting the colours within the currently chosen location 200 (such as swapping around black and white). Once the user has highlighted a chosen location 200 at which the symbol he wishes to enter is displayed, then the user may use an enter-key on the keyboard 106b to select that location 200, and hence input the symbol displayed at that location 200. It will be appreciated that other methods of using the keyboard 106b may be used to select a location 200 and thereby input a correspondingly displayed symbol.

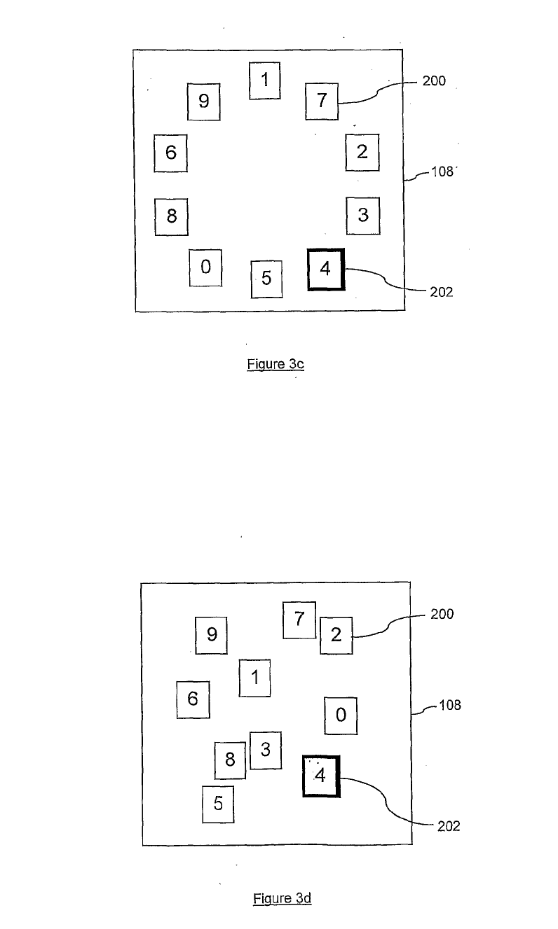

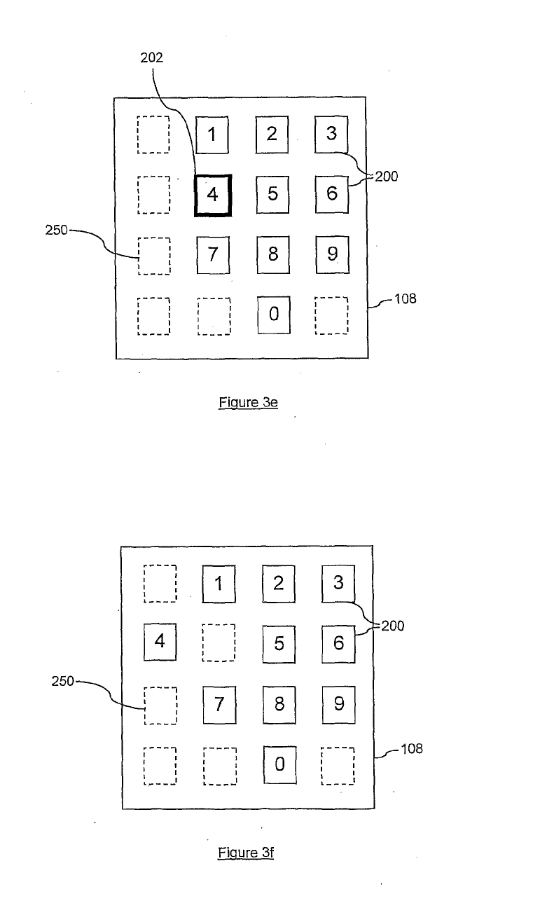

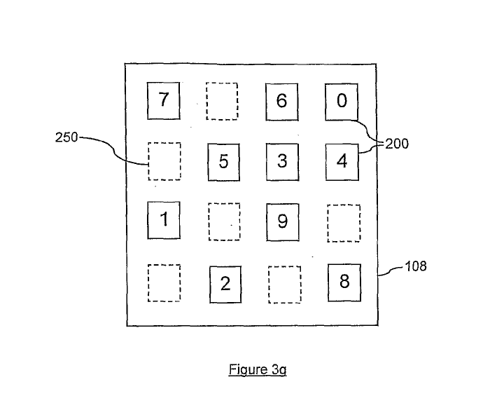

At the beginning of the input by the user, embodiments of the invention generate an order, or an arrangement, in which to display the plurality symbols. This order is a mapping that associates each symbol with a corresponding location 200 at which to display that symbol on the display 108b. The mapping determines the relative positions at which the plurality of symbols are displayed, i.e. the position at which one symbol is displayed relative to another symbol. The symbols are then displayed at the locations 200 in accordance with that mapping. Preferably, this mapping is a random or arbitrary mapping (or at least a pseudo-random order or a substantially random mapping that may be substantially statistically indistinct from a truly random mapping for displaying the symbols). FIGS. 3a and 3b schematically illustrate the symbols of FIG. 2 displayed on the display 108b using two different generated mappings, although it will be appreciated that all other possible mappings of the symbols may be used, including the conventional arrangement shown in FIG. 2. Methods of determining the mapping for displaying the plurality of symbols will be described later.

Although FIGS. 2, 3a and 3b illustrate mapping the symbols to locations 200 in a regular grid (or a set) of predetermined locations 200, the locations 200 used for the mapping need not be in such a regular grid. FIGS. 3c and 3d schematically illustrate the symbols of FIG. 2 displayed on the display 108b using two further different generated mappings. In FIG. 3c, the locations 200 are arranged in a circle. In the embodiments shown in FIGS. 2, 3a, 3b and 3c, the mappings use a predetermined set of locations 200 (or at least a subset of a predetermined set of locations 200), i.e. the locations 200 may be distributed across the display 108b in a predetermined manner. However, alternative embodiments of the invention may generate the set of locations 200 to be used in a non-predetermined or random manner when the mapping is generated. For example, the set of locations 200 to use for the current mapping may be randomly chosen coordinates on the display 108b, or randomly chosen non-overlapping areas on the display 108b. Thus, as shown in FIG. 3d, the locations 200 may be scattered and distributed randomly on the display 108b. There may be a predetermined set of possible locations 200 available for use, and the generation of the mapping identify a subset of this predetermined set of possible locations 200 with which to associate with the symbols.

In this way, the location 200 at which a symbol is displayed on the display 108b is disassociated from the position of that symbol in the natural order for the set of symbols. In other words, the meaning of (or information content represented by) a symbol is not connected, linked or related to the location 200 at which that symbol is displayed. In particular, as discussed below in more detail, embodiments of the invention generate the mapping independently of a natural ordering for the symbols, i.e. the generation of the mapping does not use the natural ordering as a basis for associating symbols with locations 200. It is by virtue of the mapping that a location 200 selected by a user can then be associated with a symbol and its meaning—without knowing the mapping, a spyware application (such as a key-logger) will not be able to deduce the meanings of the input received from the user.

Furthermore, the location 200 at which a symbol is displayed may be changed between successive times that the user wishes to enter an amount of information. For example, the first time a user enters his password, the symbols may be displayed in the order shown in FIG. 3a and then the second time the user enters his password, the symbols may be displayed in the different order shown in FIG. 3b.

Additionally, the set of locations 200 used to display the symbols may change between successive times that the user wishes to enter an amount of information. For example, the first time a user enters his password, the symbols may be displayed using the set of locations shown in FIG. 3a and then the second time the user enters his password, the symbols may be displayed using the set of locations shown in FIG. 3c or 3d. The choice of the locations 200 to use may be a random or arbitrary choice of a number of locations 200 from a plurality of all possible locations 200 for the display 108b (such as a random selection of 10 coordinates from the entire coordinate-space for the display 108b). Alternatively, there may be a plurality of predefined sets of locations 200 (such as the three arrangements shown in FIGS. 3b, 3c and 3d), and the particular predefined set of locations 200 to use for the current user input may be randomly chosen.

The full range of symbols may be made available to the user by dividing the full set of symbols into a number (such as 3 or 4) of subsets. For example, a first subset could comprise the numbers 0,1,2, . . . 9, a second subset could comprise lower case letters, a third subset could comprise upper case letters, and a fourth subset could comprise punctuation marks. The user may navigate between the subsets, with a currently selected subset of symbols being displayed accordingly. The user can then select a symbol from the currently displayed subset of symbols. However, the symbols that make up a particular subset could be changed between successive times that the user wishes to enter an amount of information. For example, if n subsets are to be used, the full set of symbols could be randomly divided into these n subsets, which may or may not each have the same number of symbols. Indeed, the value of n may be randomly selected between successive times that the user wishes to enter an amount of information.

Furthermore, the set of symbols may include navigation-symbols to enable the user to navigate between the subsets of symbols. In this way, the location of the navigation-symbols may also be varied between successive user inputs, so that an attacker (such as a key-logger application) will not be able to determine when the user has swapped between subsets of symbols.

Alternatively, the symbols to be displayed may be chosen to comprise the set of symbols that the user might possibly want to use, together with further additional symbols. For example, if the user's input is to be numerical, then the symbols to be displayed may comprise the set of numbers {0,1, . . . , 9} together with additional symbols (such as letters and punctuation). The additional symbols may be randomly chosen and there may be a random number of additional symbols.

Thus, a person using a key-logger application to monitor and log the key-strokes entered by a user at the keyboard 106b will not be able to deduce the information entered by the user, due to this disassociation. For example, if the cursor 202 always starts at the top-left location 200 shown in FIGS. 2, 3a and 3b, then, for the user to initially enter the number 4: (i) in FIG. 2, the user will have to press the down-cursor key once; (ii) in FIG. 3a, the user will have to press the down-cursor key twice; and (iii) in FIG. 3b, the user will have to press the down-cursor key once and the right-cursor key twice. As the key-logger application will not be aware of the particular mapping being used to display the symbols, the person who is using the key-logger application will not be able to determine from these key-stokes what the value of the entered symbol will be. This is due to the key-strokes only revealing the location 200 for the selected symbol, but not revealing the actual symbol being displayed at that location 200 (due to the disassociation of locations 200 and meanings of displayed symbols resulting from the mapping being used). The same applies to selections of locations 200 when the set of locations 200 being used are as shown in FIGS. 3c and 3d, or indeed, any other set of locations 200.

Similarly, a person using an application to monitor and log the display-touches made by a user at a touch-sensitive display 108b will not be able to deduce the information entered by the user, due to this disassociation. For example, for the user to enter the number 4, the user will have to touch the display 108b at a different location 200 depending on whether the mapping shown in FIG. 2, 3a, 3b, 3c, or 3d, or indeed any other mapping, is being used. As the application will not be aware of the particular mapping being used to display the symbols, the person who is using the application will not be able to determine from these display-touches what the value of the entered symbol will be. This is due to the display-touches only revealing the location 200 selected by the user, but not revealing the actual symbol being displayed at that location 200 (due to the disassociation of locations 200 and meanings of displayed symbols resulting from the mapping being used).

Additionally, an attacker performing shoulder-surfing will not be able determine the meaning of the user input unless he also observes the mapping that was used for the input. Phishing attacks are also harder to perform when such mappings are used, as doing so requires the further infrastructure for mapping generation and interpretation. Furthermore, even if the input locations from the user are transmitted to a receiver and are intercepted by an attacker, the attacker will not be able to, interpret the user's input without also knowing the mapping that was used.

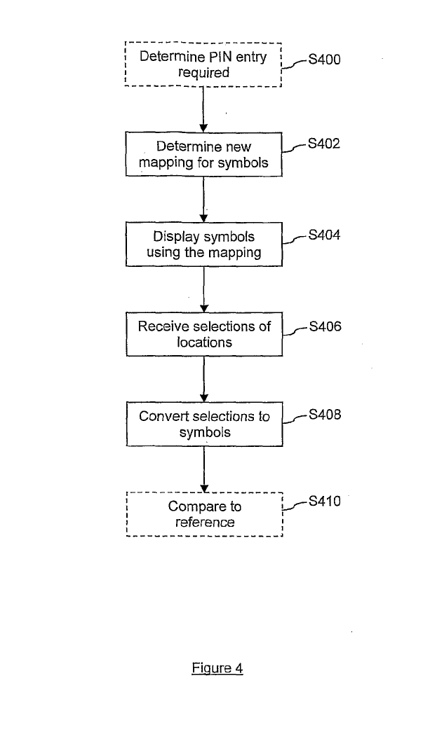

FIG. 4 schematically illustrates a flow-diagram for receiving an input from a user at the mobile device 116 according to an embodiment of the invention. The particular example shown in FIG. 4 relates to the entry by the user of a PIN.

At a step S400, it is determined (or detected) that the user should now enter the PIN. This may be performed by an application that is executing on the processor 104b of the mobile device 116 determining itself that the user should enter the PIN. For example, the PIN may be needed by the application in order to allow the user to log-in to the mobile device 116. The application will therefore prompt the user to input his PIN. Alternatively, the step S400 may be performed by the computer system 114. For example, the user may be using the mobile device 116 to interact with the computer system 114 and the computer system 114 may determine that, for the interaction to continue past a certain stage, the user must authenticate his identity by entering a PIN number. The computer system 114 then communicates to the mobile device 116 that the PIN needs to be entered by the user. The mobile device 116 receives and detects this communication and will then prompt the user to input his PIN.

At a step S402, a mapping for displaying the symbols is generated. This mapping is a mapping that associates each of the plurality of symbols with a corresponding location 200 on the display 108b. This will be described in more detail later.

At a step S404, the symbols are displayed using the generated mapping, each symbol being displayed at the location 200 with which it is associated according to the generated mapping, for example as shown in FIGS. 2, 3a, 3b, 3c and 3d.

At a step S406, the user provides a sequence of selections, each selection being a selection of a respective one of the locations 200 being used to display a symbol. This sequence of selections may be the selection of a single location 200 (to enter just one symbol), or a series of more than one location 200 (to enter a plurality of symbols). Methods of selecting a location 200 have been described above (for example, using the keyboard 106b and cursor 202, or using a touch-sensitive display 108b). In this way, the user has selected the symbol(s) that is (are) displayed at the selected location(s) 200.

At a step S408, the sequence of selections input by the user at the step S406 is converted into a corresponding sequence of input symbols that represent the input from the user. Each of the input symbols is the symbol associated with the respective selected location 200 in the sequence of selections. For example, if the symbols are displayed as shown in FIG. 3a and the sequence of locations 200 selected by the user is (a) the top-left location 200, then (b) the top-right location 200, then (c) the very bottom location 200, then (d) the top-left location 200, then the corresponding sequence of input symbols is 6756. If the symbols had been displayed as shown in FIG. 3b instead, then this sequence of selected locations 200 would correspond to the sequence of input symbols 8378.

At a step S410, to verify (validate or authenticate) the PIN entered by the user, the sequence of input symbols is compared with a reference sequence of symbols. For example, the mobile device 116 or the computer system 114 may store the actual PIN of the user (or at least a cryptographically converted version, such as a hashed version, of the actual PIN as is known in this field of technology), and the mobile device 116 or the computer system 114 may then compare the sequence of input symbols representing the PIN entered by the user with the reference symbols representing the correct PIN. If the two match, then the PIN entered by the user is authenticated; otherwise, the PIN entered by the user is not authenticated.

If the comparison at the step S410 is performed at the computer system 114, then the computer system 114 must be informed of the input from the user. This may be achieved by communicating the sequence of selected locations 200 to the computer system 114 (in which case the steps S408 and S410 are performed at the computer system 114) or may be achieved by communicating the corresponding sequence of input symbols to the computer system 114 (in which case the step S408 is performed at the mobile device 116 and the step S410 is performed at the computer system 114).

The step S408 may be performed after all of the locations 200 have been selected by the user at the step S406 (for example, in embodiments in which a complete sequence of selected locations 200 is to be communicated to the computer system 114). Alternatively, the step S408 may be performed in parallel with the step S406, so that as a location 200 is selected by the user, that selection is converted into a corresponding input symbol (i.e. the symbol displayed at that selected location), which is then added to the sequence of input symbols.

It will be appreciated that the method described above with reference to FIG. 4 applies equally to entry of data at the computer 102 or at another other device. Additionally, it will be appreciated that the method described above with reference to FIG. 4 applies equally to other data entered by the user, and not just to PINs. Furthermore, some data entered by the user will not necessarily be entered in response to a determination that data should be entered, so that the step S400 is optional. Additionally, some data entered by the user will not necessarily need to be compared to a reference (such as an entered bank account number or credit card number), so that the step S410 is optional.

The step S402 is performed at runtime, i.e. the symbols are not displayed in a predetermined manner that is fixed when compiling and creating the application which is being executed to receive the user input. However, the step S402 may be performed as shown in FIG. 4 (i.e. when it is detected that a user is about to provide an input), or the step S402 may be performed after the user has completed providing his current input, so that the generated mapping is available immediately for the next user input.

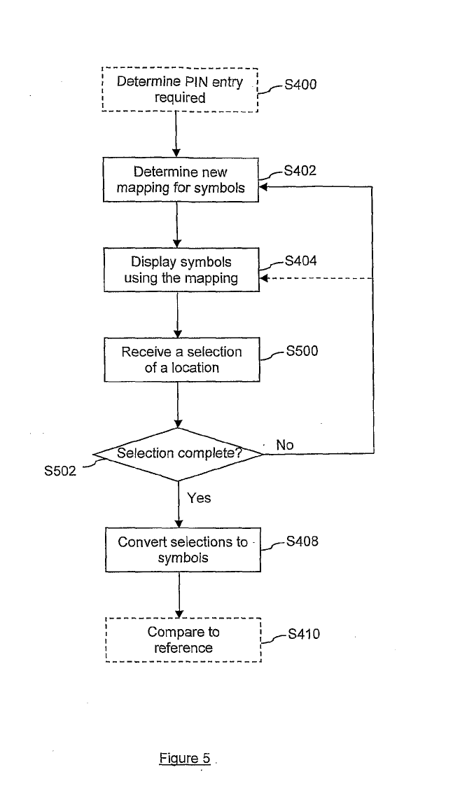

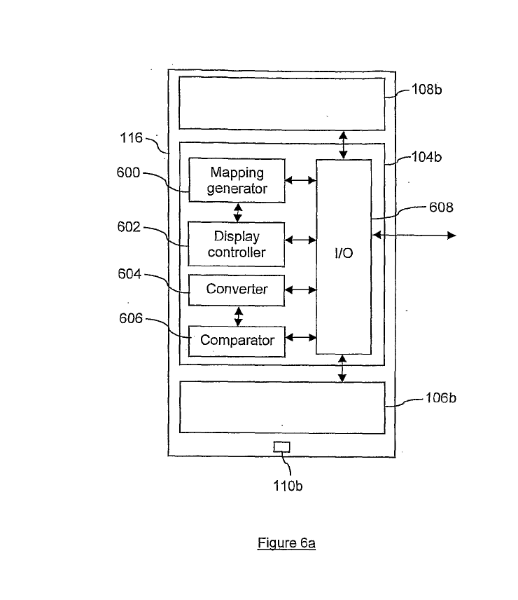

FIG. 5 schematically illustrates an alternative flow-diagram for receiving an input from a user at the mobile device 116 according to an embodiment of the invention. The processing shown in FIG. 5 is very similar to that shown in FIG. 4 and the steps that they have in common share the same reference numeral and will not be described again. Thus, the above description of FIG. 4 applies equally to the processing illustrated in FIG. 5, except as described below.

In FIG. 5, the step S406 of FIG. 4 is replaced by steps S500 and S502. At the step S500, one of the locations 200 is selected by the user to input a symbol. Processing then continues to the step S502, at which it is determined whether the selection of input symbols and locations 200 by the user is now complete. For example, there may be an “Enter” image displayed on the display 108b (not shown in FIG. 2, 3a, 3b, 3c or 3d) which the user may select to indicate that his selection of locations 200 and symbols is now complete. Alternatively, there may be a predetermined fixed length for the sequence of user selections made at the step S500, in which case the step S502 determines whether the sequence of selections made by the user so far is of the predetermined length: if not, then the selection is not complete; if so, then the selection is complete. It will be appreciated that other mechanisms for determining whether the selection by the user is now complete may be used at the step S502.

If the selection by the user is determined to be complete, then processing continues to the step S408. However, if the selection by the user is determined to be incomplete, then processing returns to the step S402, at which a new mapping for displaying the symbols is generated, and the symbols are then re-displayed at respective locations 200 based on the newly generated mapping. For example, the first selection of a symbol may be based on the symbols being displayed in the mapping shown in FIG. 3d and then the second selection of a symbol may be based on the symbols being displayed in the mapping shown in FIG. 3b.

The processing shown in FIG. 5 has the following advantage over the processing shown in FIG. 4. In FIG. 4, the person using the key-logger application or the application logging display-touches can determine whether, and how often, a symbol is repeated in the input provided by the user. For example, if the order shown in FIG. 3a is being used for the processing of FIG. 4 and if the PIN to be entered by the user is 7777, then the user will select the top-right location 200 four times in a row, and this repeated selection will be deducible by the person logging the key-strokes or display-touches. That person will not know what the actual repeated number/symbol is, but the knowledge that the same number is repeated four times narrows down the possible inputs by the user dramatically. However, when the processing of FIG. 5 is used, then it will not be possible for that person to determine that the user has entered the same number four times. Thus, the processing of FIG. 5 provides enhanced security over that shown in FIG. 4. However, the processing of FIG. 4 may be less confusing for the user, as the processing of FIG. 4 maintains the same order for displaying the symbols throughout the current input by the user.

Thus, the processing shown in FIG. 4 uses the same mapping for the entirety of the current input from the user, whilst the processing shown in FIG. 5 changes the mapping after each selection of a symbol (or location 200) by the user. Embodiments of the invention may also make use of a middle ground between these two extremes. For example, the processing at the step S500 may receive a number of user selections before proceeding to the step S502, so that the mapping is updated each time that number of selections is provided by the user. This number may be a predetermined number or may be randomly generated each time the step S500 is reached (for example, a random number in the range 1 to 10). Thus, in these ways, the steps of generating the mapping and displaying the symbols are performed for subsections of the current input from the user, a subsection being an individual symbol or a plurality of symbols making up a part of the input provided by the user.

In FIG. 5, a new mapping is generated after each location 200 is selected. However, it will be appreciated that the mapping that is, generated at the step S402 may in fact be a sequence of several mappings (e.g. a first mapping to be used for the first user selection, and a second mapping to be used for the second user selection, and so on). Thus, when it is determined at the step S502 that the selection by the user is incomplete, the processing may return to the step S404 (instead of to the step S402), at which the next mapping in the sequence of mappings generated at the step S402 is used. This is illustrated by the dashed-line shown in FIG. 5.

The new mapping generated at the step S402 may be related to a previously (e.g. immediately preceding) mapping that has been used. For example, when a symbol has been selected at the step S500 (by selecting a location 200), then the location 200 at which that symbol is displayed may simply be swapped with the location 200 at which another one of the symbols is displayed.

Additionally, or, alternatively, the number of available locations 200 on the display 108 may be greater than the number of symbols that are to be displayed, so that there are one or more free (available or reserved or excess) locations 250 (as shown by the dashed-boxes in FIGS. 3e-3g). For a current mapping, a symbol is not displayed at a free location 250 and no symbol is associated with a free location 250. FIGS. 3e-3g shown the display of the ten numbers 0 to 9 as symbols in a 4×4 grid made up of display locations 200 and free locations 250 (there being 10 current display locations 200 and six free locations 250), although, of course, other configurations of display locations 200 and free locations 250 could be used. When a location 200 at which a symbol is displayed is selected by a user at the step S500, then the new mapping generated at the step S402 subsequent to that selection may be the same as the current mapping except that the location 200 at which that selected symbol is to be display is changed or set to be one of the free locations 250, and the location 200 at which that selected symbol had been displayed is changed to or becomes a free location 250. For example, when the current mapping is as shown in FIG. 3e and the symbol “4” is selected, then the location 200 at which that symbol “4” is to be displayed may be updated to one of the free locations 250 (in this case, the one immediately to the left), as shown in FIG. 3f. In this way, the locations 200 at which the symbols are displayed will become mixed up, for example as shown in FIG. 3g. The free location 250 that is converted to a location 200 at which to display a symbol may be selected from any of the currently available free locations 250 randomly. In this way, the association of the selected symbol with its current location 200 is updated so that it is then associated with one of the free locations 250 instead (and that current location 200 is then no longer associated with any symbol for the updated and newly generated mapping).

As for FIG. 4, the step S408 may be performed after all of the locations 200 have been selected by the user at the step S500 (for example, if the complete sequence of selected locations 200 is to be communicated to the computer system 114). Alternatively, the step S408 may be performed in parallel with the step S500, so that as a location 200 is selected by the user, that selection is converted into a corresponding input symbol (i.e. the symbol displayed at that selected location), which is then added to the sequence of input symbols.

A plurality of inputs may be entered by the user. These inputs could, for example, comprise the PINs or passwords entered each time the user logs-in to the mobile device 116, various bank account numbers, telephone numbers, etc. In one embodiment of the invention, the mapping to be used is generated once and is used by that user for all subsequent inputs by the user, i.e. the step S402 is performed only for the first input by the user, this step being omitted for subsequent inputs by the user. In alternative embodiments of the invention, a different mapping may be generated between successive inputs from the user, so that the mapping is changed from one input from the user to the next, i.e. the step S402 is performed for every user input. Alternatively, the mapping may be generated/changed at a different frequency, such as every 3rd or 10th input from the user, so that the step S402 may be performed for some, but not all, user inputs in dependence upon this frequency. This frequency may be randomly generated.

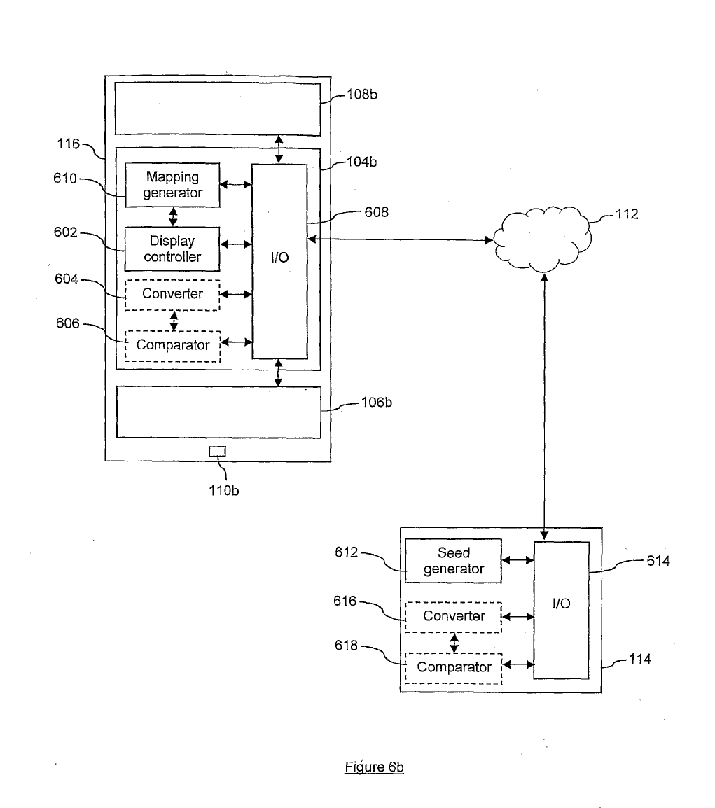

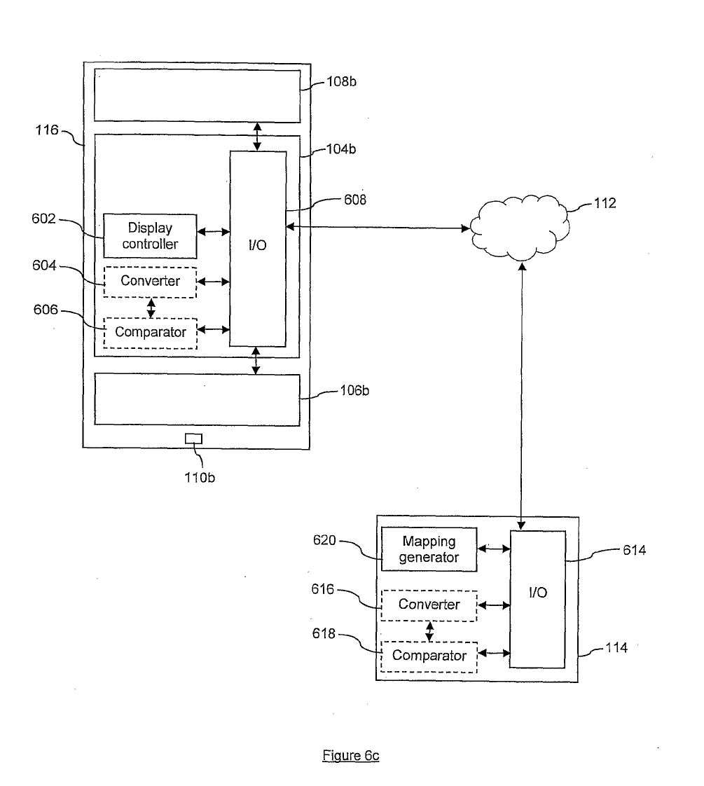

The mapping(s) to be used may be determined in a number of ways as discussed below. These methods are discussed with reference to the mobile device 116 and FIGS. 6a, 6b and 6c which illustrate various features of the mobile device 116. However, it will be appreciated that this description applies equally to other devices and apparatus at which embodiments of the invention are used.

### Method A

When the entry of the data is purely under the control of, and for the use by, the mobile device 116, then the mobile device 116 may generate a seed (using any well-known method) and use this seed to generate a random mapping (again, using any well-known method of randomisation) for displaying the symbols, i.e. the order in which to associate the symbols with the locations 200. As discussed above, this may also involve determining which set of locations 200 to use for displaying the symbols (such as randomly selecting the locations 200 to use from a predetermined set of available locations 200, or selecting one set of locations 200 from a plurality of predetermined sets of locations 200). This is particularly applicable when the mobile device 116 does not form part of the networked system 100. An example of this is when the user is logging-in to the mobile device 116 using a PIN.

FIG. 6a schematically illustrates a mobile device 116 arranged to carry out the embodiments of the invention using this method of generating the mapping. The mobile device 116 has a mapping generator 600 arranged to generate the seed and then use the seed to generate the random mapping as discussed above. A display controller 602 is provided for controlling, via an input/output interface 608, the visual display shown to the user on the display 108b. The display controller 602 receives the generated mapping from the mapping generator 600 and causes the symbols to be displayed at their associated locations 200 accordingly.

The interface 608 also receives input from the user, for example: (i) via the keyboard 106b if the keyboard 106b is provided; and/or (ii) if the display 108b is touch-sensitive, via the display 108b. The inputs received from the user are passed, via the interface 608, to a converter 604 that performs the conversion processing of the step S408. The output from the converter 604 is then a sequence of input symbols representing the input from the user.

The mobile device 116b may have a comparator 606 for comparing the input from the user with reference data, to carry out the processing of the step S410. This may be used, for example, when the input from the user is a password or a PIN.

The interface 608 may be arranged to communicate with apparatus external to the mobile device 116, for example via the network 112. As such, this method of generating the mapping may be used when the mobile device 116 is in communication with the computer system 114.

### Method B

When the mobile device 116 is in communication with the computer system 114, the computer system 114 may generate a seed (in the same way as in Method A above) and then communicate this random seed to the mobile device 116. Then, as in Method A above, the mobile device 116 may use the seed that it has received to generate a random mapping (again, using any well-known method of randomisation) in which to display the symbols, i.e. in which to associate the symbols with the locations 200. As discussed above, this may also involve determining which set of locations 200 to use for displaying the symbols (such as randomly selecting the locations 200 to use from a predetermined set of available locations 200, or selecting one set of locations 200 from a plurality of predetermined sets of locations 200).

FIG. 6b schematically illustrates a system arranged to carry out the embodiments of the invention using this method of generating the mapping.

The computer system 114 comprises a seed generator 612 for generating the seed. The computer system 114 has an input/output interface 614 with which is can communicate, via the network 112, with the mobile device 116. The random seed generated by the seed generator 612 is then communicated to the mobile device 116.

The mobile device 116 shown in FIG. 6b is the same as that shown in FIG. 6a, except that the mapping generator 600 of FIG. 6a is replaced by a different mapping generator 610 in FIG. 6b. The mapping generator 610 of FIG. 6b receives the seed generated by the seed generator 612 and uses this seed to generate the random mapping as discussed above.

As discussed above, the steps S408 and S410 may be performed at the mobile device 116, in which case the mobile device comprises the converter 604 and the comparator 606.

However, in an alternative embodiment, the step S410 may be performed at the computer system 114. In this case, the computer system 114 comprises a comparator 618 for carrying out the processing of the step S410. The mobile device 116 communicates the output of the converter 604, via the interface 608, the network 112 and the interface 614 to the comparator 618 of the computer system 114.

Furthermore, in an alternative embodiment, both of the steps S408 and S410 may be performed at the computer system 114. In this case, the computer system 114 comprises the comparator 618 for carrying out the processing of the step S410 and a converter 616 for performing the processing of the step S408. The mobile device 116 communicates the input sequence of selections received from the user, via the interface 608, the network 112 and the interface 614 to the converter 616 of the computer system 114. The output from the converter 604 is then a sequence of input symbols representing the input from the user, which is then passed to the comparator for the comparison/authentication processing of the step S410.

### Method C

When the mobile device 116 is in communication with the computer system 114, then the computer system 114 may generate a seed (as in Method B above) and then use this seed to generate a random mapping (again, using any well-known method of randomisation) in which to display the symbols, i.e. in which to associate the symbols with the locations 200. As discussed above, this may also involve determining which set of locations 200 to use for displaying the symbols (such as randomly selecting the locations 200 to use from a predetermined set of available locations 200, or selecting one set of locations 200 from a plurality of predetermined sets of locations 200). The computer system 114 may then inform the mobile device 116 of this generated mapping accordingly.

FIG. 6c schematically illustrates a system arranged to carry out the embodiments of the invention using this method of generating the mapping. This is the same as that shown in FIG. 6b, except that the (i) mobile device no longer requires the mapping generator 610, and (ii) the seed generator 612 of FIG. 6b is replaced by a mapping generator 620 that operates in the same manner as the mapping generator 600 of FIG. 6a. The computer system 114 can then communicate the generated mapping to the mobile device 116 so that the display controller 602 can display the symbols in accordance with the mapping received from the mapping generator 620.

Thus, in methods A and B above, the determination of the mapping is performed wholly, or at least in part, by the mobile device 116. In methods B and C above, the determination of the mapping is performed wholly, or at least in part, by the computer system 114.

As mentioned above, the set of symbols to be used (or subsets of symbols to be used) may be varied between user inputs. In this case, the above-mentioned methods for generating the mapping may also involve a step of randomly determining which symbols to use or how to distribute the symbols across subsets of symbols for display.

As mentioned above, the display of the symbols may be achieved using image data that represent one or more images (or icons or graphics), with the one or more images each depicting one or more of the symbols that are to be displayed on the display 108b. The image data is then used to display the plurality of symbols at the locations 200 in the generated arrangement determined by the mapping. The image data may be stored in one or more image files.

The image data may be stored at the mobile device 116. This is used in particular for method A above.

In an alternative embodiment, the image data are stored at the computer system 114. Doing so allows operators of the computer system 114 to easily update and modify the image data, so that the depiction of the symbols can be changed at a central location, rather than having to update each device in the system 100. The computer system 114 then communicates the image data to the mobile device 116 for display accordingly. In this case, when method C above is being used, the computer system 114 may inform the mobile device 116 of the generated mapping by sending image data (or image files) in an order corresponding to the generated mapping. This is particularly advantageous, as the mobile device 116 simply then receives and displays image data without ever knowing of the association between symbols and locations, thereby making the user input ever more secure.

For example, the computer system 114 may generate image data representing a single complete image which, when displayed on the display 108b of the mobile device, depicts the symbols at their associated locations 200. In this way, the computer system 114 does not need to inform the mobile device of the location 200 at which to display a particular symbol, as this is already handled via the compete image. This image data may then be communicated to the mobile device 116 as one or more image files to thereby inform that mobile device 116 of the mapping.

Alternatively, the computer system 114 may generate multiple quantities of image data (e.g. several image files) each depicting one or more of the plurality of symbols. As discussed above, each quantity may depict a single symbol, a row of symbols, a column of symbols, or any other grouping of symbols. The computer system 114 may the send these quantities of image data to the mobile device 116 in a particular order, with the mobile device 116 then displaying the image from a received quantity of image data at a location 200 determined by the position of that received quantity of image data in the transmission order. For example, the image of a first image file may be displayed at a predetermined first location 200, then the image of a second image file may be displayed at a second predetermined location 200, and so on. When separate image files are sent in this way, they may be given random filenames, or may be given simply files names such as “image1.bmp”, “image2.bmp”, etc. When the user has finished selecting the locations 200 to input symbols, then the mobile device 116 may inform the computer system 114 of the sequence of selected images that corresponds to the sequence of selected locations, for example by supplying the corresponding sequence of filenames or by supplying an indication such as “3rd image, 6th image, 4th image, 3rd image”.

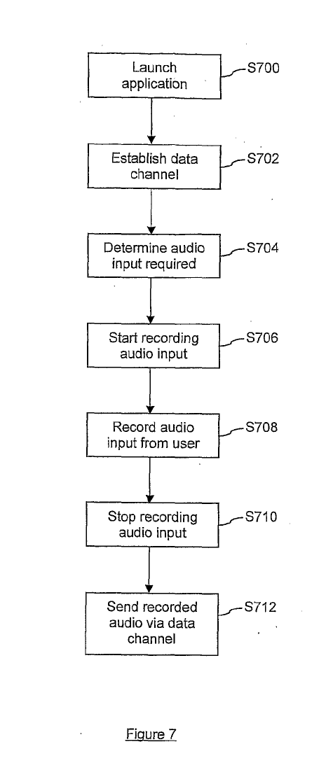

FIG. 7 schematically illustrates a flow-diagram for receiving audio input from a user at the mobile device 116. The processing shown in FIG. 6 may be applied, for example, when the processor 104b of the mobile device 116 is executing an application that interacts with the computer system 114 via a data channel that has been established over the network 112 between the computer system 114 and the mobile device 116. In such a scenario, the computer system 114 may require the user to provide an audio input. This may be, for example, to enable the computer system 114 to perform authentication of the user via voice biometrics checking (as described above). However, it will be appreciated that the computer system 114 may require the audio input from the user for other purposes, such as to record a personalised voice message for a recipient who has been designated by the user.

At a step S700, the application is launched at the mobile device 116 and the processor 104b of the mobile device 116 begins executing the application.

At a step S702, a data channel is established between the mobile device 116 and the computer system 114 so that the mobile device 116 and the computer system 114 may communicate with each other and transfer data between each other via this data channel. The person skilled in this field of technology will appreciate that this may be performed using any of the many well-known methods for establishing a data channel, such as data channel establishment functionality within any of the GPRS, UTMS, EDGE, WiFi and WiMAX standards.

Then, at a step S704, it is determined that audio input from the user is required. It may be the computer system 114 that determines that audio input is required from the user, for example if the computer system 114 needs to authenticate the, identity of the user via voice biometrics to allow the user (and the application which is being executed by the processor 104b) to proceed past a certain stage. In this case, the computer system 114 notifies the mobile device 116 that audio input is required from the user and, in response, the application being run by the mobile device 116 then prompts the user to provide an audio input via the microphone 110b. Alternatively, it may be the mobile device 116 itself (via the application) that determines that audio input is required from the user, in which case the application prompts the user to provide an audio input via the microphone 110b. For example, the application may already know that the user will, at some stage, have to provide the audio input and may therefore chose to request the audio input from the user at a stage determined by the application.

At a step S706, the application uses the microphone 110b to start recording audio input from the user. This may be achieved, for example, by the application activating the microphone 110b of the mobile device 116 so that sound received at and detected by the microphone 110b can be converted into digital audio input data.

At a step S708, the audio input received via the microphone 110b is recorded by the application and is stored as input audio data.

At a step S710, the application stops recording input audio data received via the microphone 110b. For example, the application may deactivate the microphone 110b of the mobile device 116 so that further sound provided to the microphone 110b is no longer recorded by the application.

Then, at a step S712, the application communicates the recorded input audio data to the computer system 114 via the data channel that was established at the step S702. If authentication is then to take place (such as voice biometrics authentication), the computer system 114 may compare the audio data that is received with reference audio data. If the two match, then the audio input from the user is validated; otherwise, the audio input from the user is not validated.

Thus, a separate voice channel is not established using the processing shown in FIG. 7 and, as a consequence, the application launched at the step S700 is not interrupted, or terminated, when the user provides the input audio. Additionally, the previously experienced loss of data to due having to establish a voice channel for transmitting the audio data to the computer system 114 is avoided.

The step S710, at which recording of audio data is stopped may be performed a predetermined amount of time after starting to record the audio data at the step S706. Alternatively, the application may be arranged to analyse the recorded audio data to detect a period of relative silence in the recorded audio data. Then, if a contiguous section of relative silence lasting a predetermined amount of time is identified by the application, then the application may assume that the user has finished providing the audio input, in which case the application proceeds to the step S710 to stop the recording of the audio data.

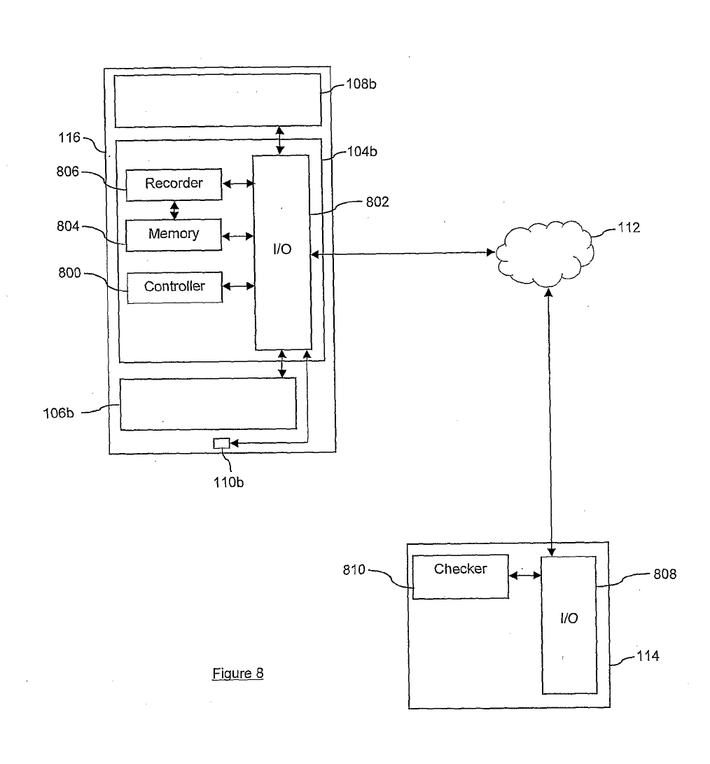

FIG. 8 schematically illustrates an apparatus (in this case, the mobile device 116) for carrying out the processing shown in FIG. 7.

The mobile device 116 comprises a memory 804 for storing audio data. The memory 804 also stores the application to be executed by the processor 104b. The processor 104b may therefore execute the application by reading the application from the memory 804 and carrying out the instructions of the application accordingly.

The mobile device 116 comprises a controller 800 for controlling the microphone 110b. This may be achieved, for example, via an input/output interface 802. The controller 800 may be formed from hardware of the mobile device 116 under the control of the application running on the processor 104b. Thus, the controller 800 may be arranged to activate and deactivate the microphone 110b in accordance with the requirements of, and under the control of, the application that is being executed.

The recording of audio from the user is under the control of a recorder 806 that is arranged to convert audio signals received from the microphone 110b into digital data for storing in the memory 804. Audio signals may be passed from the microphone 110b to the recorder 806 via the interface 802.

The interface 802 is arranged to establish, and communicate via, a voice channel and a data channel. As mentioned, the application communicates with the computer system 114 via a data channel that has been established over the network 112 between the mobile device 116 and the computer system 114. The interface 802 is arranged to supply the recorded audio data from the memory 804 to the computer system 114 via this data channel. The computer system 114 has an input/output interface 808 for receiving the recorded audio data from the mobile device 116 via this data channel. A comparator 810, or checker, may be provided at the computer system 114 for checking the recorded audio input received from the user by comparing the recorded data with reference audio data.

1. A method of securing the inputting of sensitive information by a user, the method comprising:
generating a mapping that associates each symbol of a plurality of symbols with a respective location at which to display that symbol on a display;
displaying the plurality of symbols to the user, each symbol being displayed at the associated location on the display according to the generated mapping;
the user providing a sequence of selections, each selection being a selection of a respective one of the locations; and
converting the sequence of selections into a corresponding sequence of input symbols representing the input from the user, each input symbol being the symbol associated with the respective selected location in the sequence of selections according to the generated mapping.

2. A method of receiving a plurality of inputs from a user, the method comprising:
for each input from the user:
generating a mapping that associates each symbol of a plurality of symbols with a respective location at which to display that symbol on a display;
displaying the plurality of symbols to the user, each symbol being displayed at the associated location on the display according to the generated mapping;
the user providing a sequence of selections, each selection being a selection of a respective one of the locations; and
converting the sequence of selections into a corresponding sequence of input symbols representing the input, each input symbol being the symbol associated with the respective selected location in the sequence of selections according to the generated mapping;
wherein the mapping generated for a first input from the user is different from the mapping generated for a second input from the user.

3. A method according to claim 1, in which the plurality of symbols have a natural ordering and in which the mapping is generated independently of the natural ordering.

4. A method according to claim 1, in which the mapping is a substantially random mapping.

5. A method according to claim 1, in which the step of generating is performed at least in part at a first system and the steps of displaying and providing are performed at a second system distinct from the first system.

6. A method according to claim 5, in which the step of generating comprises:
the first system generating a seed value and communicating the seed value to the second system; and
the second system using the seed value to generate the mapping.

7. A method according to claim 5, in which the step of generating comprises the first system:
generating a seed value;
using the seed value to generate the mapping; and
communicating the mapping to the second system.

8. A method according to claim 5, comprising:
the first system generating the mapping;
the first system communicating image data to the second system, the image data defining an image which, when displayed at the second system, depicts the plurality of symbols at the associated locations in accordance with the generated mapping; and
the second system displaying the plurality of symbols by displaying the image defined by the image data.

9. A method according to claim 5, in which the step of converting is performed at the first system, the method comprising communicating the sequence of selections from the second system to the first system.

10. A method according to claim 1, comprising the step of checking the input from the user by comparing the sequence of input symbols with a reference sequence of symbols from the plurality of symbols.

11. A method according to claim 10, in which the step of checking is performed at the first system.

12. A method according to claim 1, comprising:
detecting that the user is about to provide an input, wherein the step of generating is performed in response to a detection that the user is about to provide an input.

13. A method according to claim 1, in which the step of generating comprises selecting the locations to use for the mapping from a set of available locations.

14. A method according to claim 1, in which the sequence of selections for an input is a single selection.

15. A system adapted to secure the inputting of sensitive information by a user, the system comprising:
a display;
a mapping generator for generating a mapping that associates each symbol of a plurality of symbols with a respective location at which to display that symbol on the display;
a display controller for displaying the plurality of symbols to the user, each symbol being displayed at the associated location on the display according to the generated mapping;
means for receiving a sequence of selections from the user, each selection being a selection of a respective one of the locations; and
a converter for converting the sequence of selections into a corresponding sequence of input symbols representing the input from the user, each input symbol being the symbol associated with the respective selected location in the sequence of selections according to the generated mapping.

16. A system adapted to receive a plurality of inputs from a user, the system comprising:
a display;
a mapping generator for generating a mapping that associates each symbol of a plurality of symbols with a respective location at which to display that symbol on the display, wherein the mapping generated for a first input from the user is different from the mapping generated for a second input from the user;
a display controller for displaying the plurality of symbols to the user, each symbol being displayed at the associated location on the display according to the generated mapping;
means for receiving a sequence of selections from the user, each selection being a selection of a respective one of the locations; and
a converter for converting the sequence of selections into a corresponding sequence of input symbols representing the input from the user, each input symbol being the symbol associated with the respective selected location in the sequence of selections according to the generated mapping.

17. A system according to claim 15, in which the plurality of symbols have a natural ordering and in which the mapping is generated independently of the natural ordering.

18. A system according to claim 15, in which the mapping is a substantially random mapping.

19. A system according to claim 15, comprising a first system in communication with a second system, in which the first system comprises at least a part of the mapping generator and in which the second system comprises the display, the display controller and the means for receiving.

20. A system according to claim 19, in which the mapping generator comprises:
a seed generator at the first system for generating a seed value, the first system being arranged to communicate the seed value to the second system; and
means for generating the mapping at the second system using the seed value.

21. A system according to claim 19, in which mapping generator comprises:
a seed generator at the first system for generating a seed value; and
means for generating the mapping at the first system using the seed value;
in which the first system is arranged to communicate the mapping to the second system.

22. A system according to claim 19, in which mapping generator comprises means for communicating image data from the first system to the second system, the image data defining an image which, when displayed at the second system, depicts the plurality of symbols at the associated locations in accordance with the generated mapping.

23. A system according to claim 19, in which the first system comprises the converter, the second system being arranged to communicate the sequence of selections to the first system.

24. A system according to claim 19 comprising means for checking the input from the user by comparing the sequence of input symbols with a reference sequence of symbols from the plurality of symbols.

25. A system according to claim 24, in which the means for checking is provided at the first system.

26. A system according to claim 15, comprising:
means for detecting that the user is about to provide an input, wherein the mapping generator is arranged to generate the mapping in response to a detection that the user is about to provide an input.

27. A system according to claim 15, in which the mapping generator is arranged to select the locations to use for the mapping from a set of available locations.

28. A system according to claim 15, in which the sequence of selections for an input is a single selection.

29. (canceled)

30. (canceled)

31. (canceled)

32. (canceled)

33. (canceled)

34. (cancelled)

35. (cancelled)

36. A data carrying medium carrying a computer program which, when executed by a computer, secures the inputting of sensitive information by a user, by:
generating a mapping that associates each symbol of a plurality of symbols with a respective location at which to display that symbol on a display;
displaying the plurality of symbols to the user, each symbol being displayed at the associated location on the display according to the generated mapping;
the user providing a sequence of selections, each selection being a selection of a respective one of the locations; and
converting the sequence of selections into a corresponding sequence of input symbols representing the input from the user, each input symbol being the symbol associated with the respective selected location in the sequence of selections according to the generated mapping.

37. (canceled)
